(19) United States
(12) Patent Application Publication
(10) Pub. No.: US 2011/0199456 A1
(43) Pub. Date: Aug. 18, 2011

(54) APPARATUS FOR IMAGE REPRODUCTION AND METHOD THEREFOR

(75) Inventor: Cheng-Feng Chao, Taipei City (TW)

(73) Assignee: QISDA CORPORATION, Taoyuan Shien (TW)

(21) Appl. No.: 12/704,530

(22) Filed: Feb. 12, 2010

(51) Int. Cl. H04N 13/00

(52) U.S. Cl. 348/43; 348/E13.001

(57) ABSTRACT

An apparatus for image reproduction and a method therefor are provided. The apparatus includes a processing module and a logic circuit. The processing module outputs a data signal. The logic circuit is for selectively processing a single image of the data signal and a group of images of the data signal for displaying. When the apparatus is in a synchronization mode, the logic circuit processes a data pattern of the data signal for determining a sequence of the data signal. When the apparatus is in a display mode, the logic circuit processes the group of images of the data signal according to the determined sequence. In an embodiment, the group of images indicates a three-dimensional (3-D) image for displaying by a 3-D panel.

### BACKGROUND OF THE INVENTION

1. Field of the Invention

The invention relates in general to an apparatus for image reproduction and a method therefor, and more particularly to an apparatus for three-dimensional image reproduction.

2. Description of the Related Art

People have been longing for the recording and reproducing three-dimensional (3-D) images. Traditional stereoscopic photography consists of creating a 3-D illusion starting from a pair or more number of two-dimension (2-D) images. One approach to creating depth perception in the brain is to provide the eyes of the viewer with two or more different images, representing two perspectives of the same object. Specifically, the requirement for 3-D reproduction is to enable the left eye of the viewer to see the left image and the right eye to see the right image, for example.

Due to the progress of technology and demands, electronic products for 3-D reproduction are available to the market, such as televisions, computer display panels, digital photo frames, and mobile phones. Since these products are still in the initial stage on the market, the hardware components, especially the chips for providing image data for 3-D reproduction on 3-D display panels, are implemented by using complicated, high-end solution, such as high-performance hardware or processor to handle heavy computation. This situation inevitably leads to increases in hardware complexity and costs of the products and becomes a hindrance to the popularity of these products.

### SUMMARY OF THE INVENTION

Embodiments of an apparatus for image reproduction and a method therefor are provided. According to an embodiment, a structure for selectively processing data for reproduction, e.g., by a 3-D panel of other reproduction devices, employs a logic circuit and a processing module. The requirement for image reproduction (e.g., 3-D panel) can be implemented with simplified hardware according to the embodiment, instead of complicated high-performance hardware, such as high performance processor.

According to a first aspect of the invention, an apparatus for image reproduction is provided. The apparatus includes a processing module and a logic circuit. The processing module outputs a data signal. The logic circuit is for selectively processing a single image of the data signal and a group of images of the data signal for displaying. When the apparatus is in a synchronization mode, the logic circuit processes a data pattern of the data signal for determining a sequence of the data signal. When the apparatus is in a display mode, the logic circuit processes the group of images of the data signal according to the determined sequence.

According to a second aspect of the invention, a method for image reproduction for a displaying apparatus is provided, wherein the displaying apparatus includes a logic circuit and a processing module. The method includes the following steps. A data signal is outputted from the processing module to the logic circuit. A data pattern of the data signal for determining a sequence of the data signal is then processed by the logic circuit when the displaying apparatus is in a synchronization mode. Next, selectively processing a single image of the data signal and a group of images of the data signal for displaying is performed by the logic circuit according to the determined sequence when the displaying apparatus is in a display mode.

According to a third aspect of the invention, an apparatus for image reproduction includes a processing module and a logic circuit. The processing module is for selectively outputting a single image and a pair of images when the apparatus is in a display mode and for outputting a data pattern when the apparatus is in a synchronization mode. The logic circuit is for receiving the data pattern for determining a sequence and for selectively processing the single image and the pair of images according to the sequence.

It is to be understood that both the foregoing general description and the following detailed description are exemplary and explanatory only and are not restrictive of the disclosed embodiments, as claimed. The following description is made with reference to the accompanying drawings.

### BRIEF DESCRIPTION OF THE DRAWINGS

FIG. 1 shows a block diagram illustrating an apparatus for image reproduction according to an embodiment of the invention.

FIG. 2 shows a block diagram illustrating an embodiment of the logic circuit as shown in FIG. 1.

FIG. 3 shows a timing diagram illustrating an example of a method for processing image data from the processing module by the logic circuit in a display mode.

FIG. 4 shows a timing diagram illustrating an example of a method for synchronization between the processing module and the logic circuit in a synchronization mode.

### DETAILED DESCRIPTION OF THE INVENTION

According to an embodiment, an apparatus for image reproduction employs a logic circuit and a processing module as a basis for preparing data for image reproduction, e.g., 2-D or 3-D. The apparatus includes a synchronization mode to enable proper receiving of image data by the logic circuit and a display mode to employ the logic circuit to handle image data from the processing module. In some embodiments, the apparatus for image reproduction can be implemented, for example, as a display panel, digital photo frame, television, projector, or a computer system such as a mobile computing device, based on this structure for 2-D or 3-D image reproduction, such as displaying or projection.

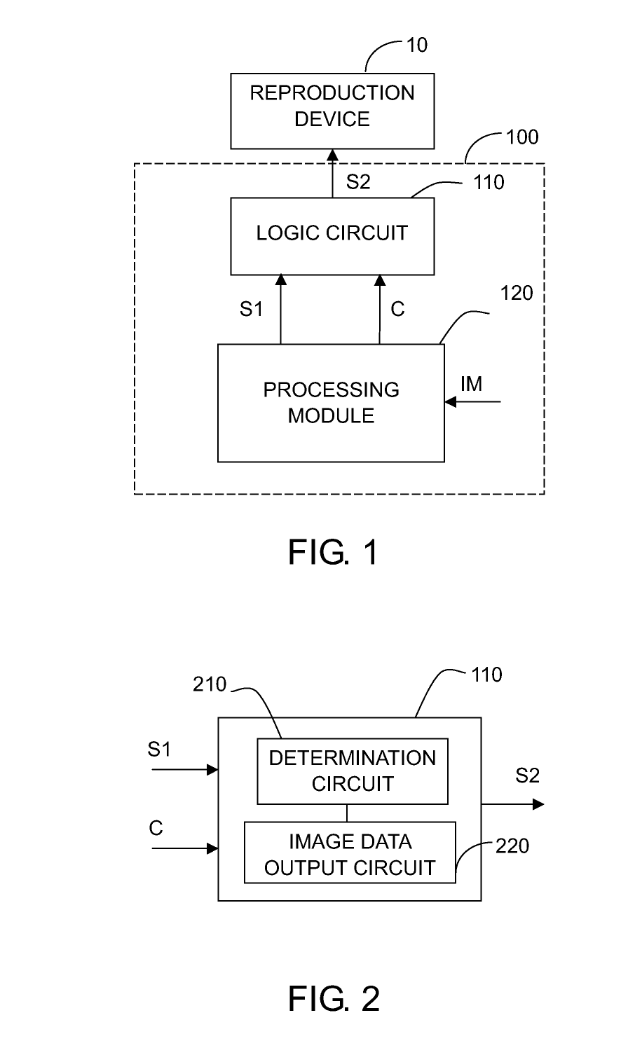

As an exemplary embodiment, FIG. 1 illustrates a block diagram of an apparatus for image reproduction. In FIG. 1, the apparatus 100 includes a logic circuit 110 and a processing module 120. The apparatus 100 has two operational modes: a synchronization mode and a display mode. Generally, at the moment, when being turned on or reset, the apparatus 100 is in the synchronization mode and the reproduction device 10 does not show any image. When the apparatus 100 comes to stable state, the apparatus 100 comes to the display mode and the reproduction device 10 is ready for showing images.

When the apparatus 100 is in the synchronization mode, the logic circuit 110, e.g., integrated logic circuitry or programmable logic chip, such as FPGA (Field Programmable Gate Array), receives or processes a data pattern from the processing module 120 for determining a sequence, i.e., an order happening or existing in image data from the processing module 120. The logic circuit 110 selectively processes a single image and a group of images for displaying from the processing module 120 according to the determined sequence when the apparatus 100 is in the display mode.

The processing module 120, e.g., a general processor, or a microcontroller-based integrated circuit, digital signal processor (DSP), or system-on-chip (SOC), or dedicated digital photo frame SOC, is for outputting a data signal, denoted by S1, such as a data stream or parallel data signals, to the logic circuit 110. In the display mode, the processing module 120 outputs the data signal indicative of a single image (e.g., 2-D image) and a group of images (e.g., frames of a multi-view 3-D image such as a pair of images with left and right frames), selectively. In an example, the processing module 120 selectively outputs a single image and multi-view images by selectively decoding an image file, e.g., files in JPEG, BMP, or TIFF format, denoted by IM, and a multi-view picture file, e.g., files in Multi-Picture format (denoted by MPO) or Audio-Video Interleave format (i.e., avi file), from a memory (e.g., a flash card or an external memory), or a data or communication interface (e.g., a USB, Fast Infrared—IrSimple or IrSimpleShot, Bluetooth, Wi-Fi, 3G, 3.5G or 4G network). In another example, the source of 2-D or 3-D images can be generated internally by the apparatus 100, e.g., for the graphical user interface of the apparatus 100. In other examples, the apparatus 100 can further includes such memory, memory card interface, or communication interface; or the processing module can be implemented as a SOC to include such components.

In a practical example, the apparatus 100 prepares appropriate image data to be outputted for reproduction by a reproduction device 10, e.g., a 3-D display panel or 3-D projector. For proper operation, the processing module 120 outputs a data pattern to the logic circuit 110 in the synchronization mode before the display mode. For example, a digital photo frame with 2-D and 3-D reproduction can be implemented based on the apparatus 100 further including the reproduction device 10, e.g., a 800×600 3-D panel. In an example, when the apparatus 100 is in the synchronization mode, the panel is blank; while when the apparatus is in the display mode, the panel is for selectively displaying a 2D image with the single image of the data signal and a 3-D image with the group of images of the data signal S1.

According to specific requirement for reproduction by the reproduction device 10, e.g., 3-D panels such as parallax barrier 3-D panel, lenticular screen, or other 3-D panels, the logic circuit 110 should be configured or adapted in design to process the data signal S1 from the processing module 120 according to the determined sequence. An embodiment of the apparatus 100 will be taken as a digital photo frame with parallax barrier technology. As an example, a logic circuit 110 as shown in FIG. 2 is for outputting a data signal S2 to the reproduction device 10. The logic circuit 110 includes a determination circuit 210 and an image data output circuit 220. The determination circuit 210 determines the data pattern indicated in the data signal S1, e.g., as shown in FIG. 4, in the synchronization mode. The image data output circuit 220, according to the determined sequence, for selectively processing the single image and the group of images of the data signal S1 for displaying by the reproduction device 10.

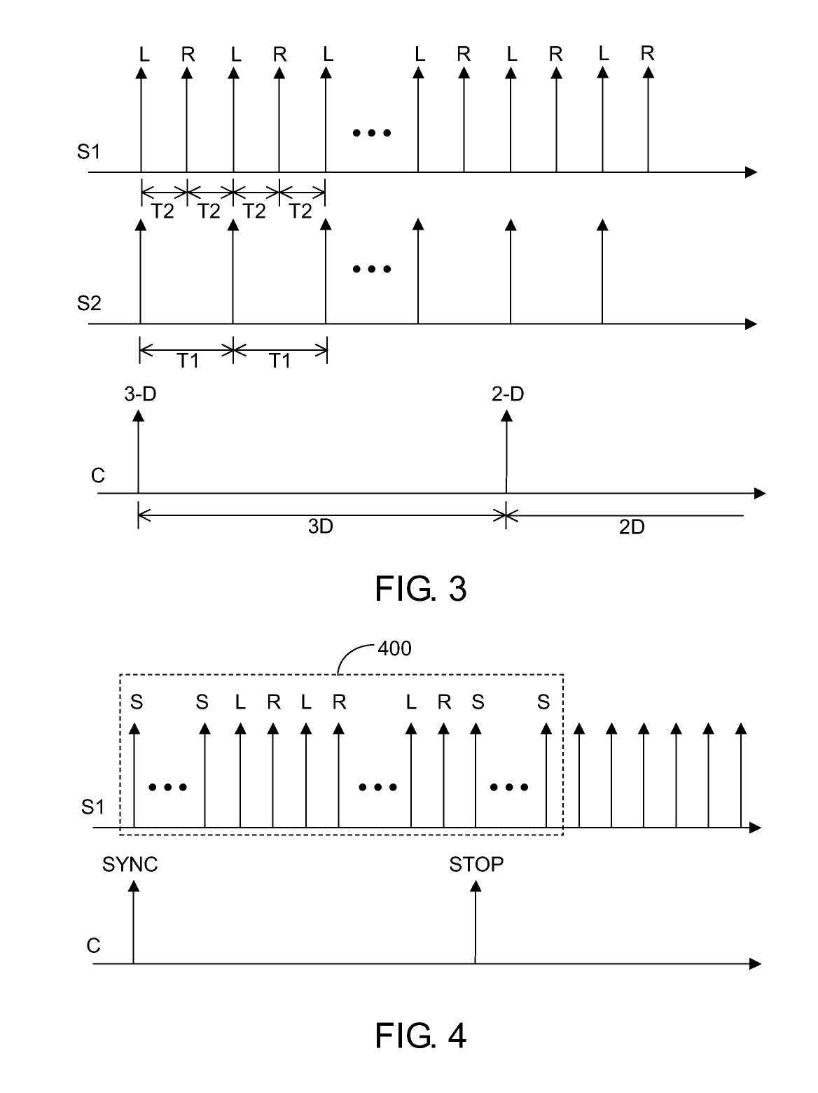

At the beginning, it is assumed that one desired 3-D content is a 3-D image with a pair of frames, e.g., for reproduction by a parallax barrier 3-D panel with a resolution of 800×600 at a frame rate of 30 fps. In an example, the logic circuit 110 processes the pair of frames (e.g., 800×600 2-D frames) of the data signal S1, in a sequence of alternate left and right frames, as shown in FIG. 3, at a frame rate of n×30 fps, i.e., 60 fps (where n=2). The logic circuit 110 outputs the processed image data (S2) repeatedly at the frame rate of 30 fps, wherein the arrows in the timing diagram indicate the transmission of frames. In the display mode, the logic circuit 110 downscales the pair of frames from the resolution of 800×600 to 400×600, and knits the two downscaled frames of 400×600 to generate a 800×600 3-D image (or content) to be outputted to the reproduction device 10. The logic circuit 110 processes a group of images (e.g., a pair of frames) of the data signal S1 for displaying in a first time period T1, wherein the first time period T1 includes substantially a number of second time periods T2 (e.g., T1 is about two times T2 in FIG. 3), the logic circuit receives each image of the group of images of the data signal in a corresponding one of the second time periods T2 according to the determined sequence.

Another desired content for reproduction is a 2-D image. In this case, the processing module 120 outputs the 2-D image through the data signal S1 and the logic circuit 110 receives the single 2-D image of the data signal S1 and outputs the single 2-D image to the reproduction device 10. For example, the frames indicated by “L” (or “R”) can be chosen to transmit the single 2-D image. In this way, the frame rate for the 2-D image from the processing module 120 can be at 30 fps, i.e., the same as that for the logic circuit 110. Thus, the logic circuit 110 can output the data signal S2 indicating the single 2-D image of the data signal S1 to the reproduction device 10. In another example, a multi-view image file can also be reproduced in 2-D manner in this way.

Further, in an embodiment, the processing module 120 can further output a command signal C, e.g., by using a serial interface or Inter-IC bus, to send a command for indicating the data signal S1 currently sent to the logic circuit 110 being selectively a single image (e.g., a 2-D image or one frame of a multi-view images) and a group of images (e.g., multi-view images, or left and right frames) and the logic circuit 110 processes the data signal S1 according to the command. In FIG. 3, the logic circuit 110, in response to the command signal C indicated by an arrow with “3-D”, processes a group of the left and right frames of the data signal S1 for 3-D reproduction. In addition, the logic circuit 110, in response to the command signal C indicated by an arrow with “2-D”, processes the single image of the data signal S1 for 2-D reproduction. In practical examples, the processing module 120 outputs the command signal C after recognizing the file by the filename extension, e.g., MPO, JPEG, and AVI, or after being to a 2-D or 3-D display mode.

For proper operation, the logic circuit 110 determines a sequence for synchronization with the processing module 120 before entering the display mode. A timing diagram in FIG. 4 illustrates an example of a method for synchronization between the processing module and the logic circuit in the synchronization mode. Initially, the processing module 120 outputs the data signal S1 indicating regular transmission of images (or frames or data in general) at a frame rate (e.g., 60 fps). First, the processing module 120 outputs a SYNC command, e.g., through a command signal C, to inform the logic circuit 110 to enter the synchronization mode. The processing module 120 begins to send a data pattern, as indicated by dashed block 400. The data patterns includes a number of pattern images, e.g., an odd number of images alternating between left and right pattern images, indicated by arrows headed “L” and “R”. In an example, the left images are set with each pixel having a specific value such as 0x00000000 and the right images are set with each pixel having a specific value such as 0xFFFFFFFF. In response to the SYNC command, the logic circuit 110 begins to detect the data pattern, e.g., by using hardware components for comparison or detection. If it is determined that left and right pattern images are alternately being received for a number times, e.g., 8, 10 or 20, the logic circuit 110 determines the sequence of the data signal 51. Following that, the logic circuit 110 begins to regard the images of the data signal 51 in the sequence. Next, the processing module 120 outputs a STOP command, as indicated by an arrow with “STOP” in FIG. 4. In response to the STOP command, the logic circuit 110 stops detection of the data pattern; i.e., the synchronization mode is stopped. In this way, after the synchronization mode, the logic circuit 100 in the display mode selectively processes a single image and a group of images of the data signal 51 according to the determined sequence.

Further, in an example, the processing module 120 additionally outputs a number of first sample images through the data signal 51 after outputting the SYNC, in order for logic circuit 110 to prepare its internal operation. Similarly, in an example, after the STOP command is outputted, the processing module 120 outputs a number of second sample images, e.g., 10 or 20, instead of the pattern images. After the second sample images, the processing module 120 begins to output normal images to the logic circuit 110. To be specific, the number of second sample images can be set to be an even number, and then the processing module 120 can start to send normal images according to the sequence. Further, in an example, the logic circuit 110 can be implemented to skip these sample images or the sample images can be set arbitrarily or just to be blank.

In addition to the above, the logic circuit 110 can enter the display mode after the synchronization is stopped, e.g., for default displaying one of 2-D and 3-D images, or selectively by a command, as illustrated above by way of FIG. 3. In other examples, the logic circuit 110 can be implemented according to another sequence and data pattern in different configuration, e.g., alternate right and left images; an odd number of the pattern images; alternate multi-view sequence such as 4 or 8 pattern images. It is noted that one can modify the above embodiment to adaptively meet the requirement for synchronization.

Regarding the synchronization and display mode, the determination circuit 210 and the image data output circuit 220 of the logic circuit 110 can be implemented according to the embodiments or examples. The logic circuit 110 can also be a FPGA configured accordingly.

In other embodiments, the data signal from the processing module 120 can also be implemented to include a specific image (i.e., specific data) to represent a specific command, such as the SYNC, STOP, 3-D, or 2-D, as illustrated above, instead of separately using a command signal C as indicated above.

In addition to the above embodiments with the parallax barrier 3-D display panel for illustration, other embodiments of electronic apparatuses employing the other 3-D reproduction technology such as lenticular screen or 3-D projection can also be implemented based on the above-illustrated inventive concept of using logic circuit to selectively process a single image and a group of images for reproduction according to a determined sequence. Furthermore, in other embodiments, the apparatus 100 can be implemented to process multi-view video with the logic circuit 110 and the processing module 120 according to the embodiment(s) above. Since the logic circuit is based on logic circuitry other than complicated high-performance hardware such as high performance processor, the products based on the embodiment can achieve the requirement for image reproduction effectively with reduced system hardware complexity, thus leading to reduced cost.

It will be appreciated by those skilled in the art that changes could be made to the disclosed embodiments described above without departing from the broad inventive concept thereof. It is understood, therefore, that the disclosed embodiments are not limited to the particular examples disclosed, but is intended to cover modifications within the spirit and scope of the disclosed embodiments as defined by the claims that follow.

What is claimed is:

1. An apparatus for image reproduction comprising:
a processing module outputting a data signal; and
a logic circuit for selectively processing a single image of the data signal and a group of images of the data signal for displaying, wherein when the apparatus is in a synchronization mode, the logic circuit processes a data pattern of the data signal for determining a sequence of the data signal; when the apparatus is in a display mode, the logic circuit processes the group of images of the data signal according to the determined sequence.

2. The apparatus according to claim 1, wherein when the apparatus is in the display mode, the logic circuit processing the single image of the data signal for displaying during a first time period.

3. The apparatus according to claim 2, wherein the logic circuit processes the group of images of the data signal for displaying during the first time period, wherein the first time period has a plurality of second time periods, the logic circuit receives the group of images of the data signal each in a corresponding one of the second time periods according to the determined sequence.

4. The apparatus according to claim 3, wherein the first time period has two second time periods, the data pattern comprises a plurality of left pattern images and right pattern images, wherein the left pattern images and right pattern images are transmitted alternately, each in a corresponding one of the two second time periods, from the processing module to the logic circuit.

5. The apparatus according to claim 4, wherein the data pattern further comprises a plurality of first sample images and a plurality of second sample images, wherein the processing module sends the first sample images, the left pattern images and the right pattern images and the second sample images to the logic circuit in series.

6. The apparatus according to claim 5, wherein the logic circuit skips the first sample images and determines the sequence of the data signal according to the left pattern images and the right pattern images and skips the second sample images then the apparatus starts the display mode.

7. The apparatus according to claim 3, further comprising a panel, wherein when the apparatus is in the synchronization mode, the panel is blank; when the apparatus is in the display mode, the panel is for selectively displaying a two-dimensional image with the single image of the data signal and a three-dimensional image with the group of images of the data signal.

8. The apparatus according to claim 1, wherein the logic circuit, in response to a synchronization command outputted by the processing module, enters the synchronization mode.

9. The apparatus according to claim 8, wherein the logic circuit, in response to a stopping synchronization command outputted by the processing module, stops the synchronization mode.

10. The apparatus according to claim 1, wherein when the apparatus is in the display mode, the processing module outputs a command for indicating the data signal sending to the logic circuit being selectively a single image of the data signal and a group of images of the data signal and the logic circuit processes the data signal according to the command.

11. The apparatus according to claim 1, wherein the logic circuit comprises:
a determination circuit for determining the data pattern indicated in the data signal in the synchronization mode;
an image data output circuit, according to the determined sequence, for selectively processing the single image of the data signal and the group of images of the data signal for displaying by a reproduction device.

12. A method for image reproduction for a displaying apparatus, the displaying apparatus comprising a logic circuit and a processing module, the method comprising:
outputting a data signal from the processing module to the logic circuit;
processing a data pattern of the data signal for determining a sequence of the data signal by the logic circuit when the displaying apparatus is in a synchronization mode; and
selectively processing, by the logic circuit, a single image of the data signal and a group of images of the data signal for displaying according to the determined sequence when the displaying apparatus is in a display mode.

13. The method according to claim 12, further comprising:
outputting a command from the processing module to the logic circuit when the displaying apparatus is in the display mode, wherein the command indicates that the data signal being sent to the logic circuit represents selectively the single image of the data signal and the group of images of the data signal; and the logic circuit processes the data signal according to the command.

14. The method according to claim 12, wherein the selectively processing step comprises:
processing the single image of the data signal to obtain first output image data and displaying the first image data, in a first time period.

15. The method according to claim 14, wherein the selectively processing step further comprises:
processing the group of images of the data signal to obtain second output image data and displaying the second output image data, in the first time period, wherein the first time period has a plurality of second time periods, and each image of the group of images of the data signal is received by the logic circuit in a corresponding one of the second time periods according to the determined sequence.

16. The method according to claim 15, wherein the first time period has two second time periods, the data pattern comprises a plurality of left pattern images and right pattern images, and the method further comprises:
alternately transmitting the left pattern images and the right pattern images, each in a corresponding one of the two second time periods, from the processing module to the logic circuit.

17. The method according to claim 16, wherein the data pattern further comprises a plurality of first sample images and a plurality of second sample images, the method further comprises:
sending the first sample images sends, the left pattern images, the right pattern images and the second sample images from the processing module to the logic circuit in series.

18. An apparatus for image reproduction comprising:
a processing module for selectively outputting a single image and a pair of images when the apparatus is in a display mode and for outputting a data pattern when the apparatus is in a synchronization mode; and
a logic circuit for receiving the data pattern for determining a sequence and for selectively processing the single image and the pair of images according to the sequence.

19. The apparatus according to claim 18, wherein the data pattern comprises:
a plurality of first sample images;
a plurality of left pattern images;
a plurality of right pattern images; and
a plurality of second sample images, wherein when the apparatus turns on, the processing module sends the first sample images, the left pattern images, the right pattern images, and the second sample images in series, wherein the left pattern images and right pattern images are transmitted alternately.

20. The apparatus according to claim 18, further comprising:
a panel for selectively displaying a two-dimensional image with the single image of the data signal and a three-dimensional image with the pair images of the data signal.
